(19) United States
(12) Patent Application Publication
(10) Pub. No.: US 2014/0030376 A1
(43) Pub. Date: Jan. 30, 2014

(54) GLUTEN-FREE READY-TO-EAT FOOD COMPOSITION

(71) Applicant: Michele Zebert Caws, Califon, NJ (US)

(72) Inventor: Michele Zebert Caws, Califon, NJ (US)

(21) Appl. No.: 13/993,050

(22) PCT Filed: Dec. 8, 2011
(86) PCT No.: PCT/US11/63998

§ 371 Date: Oct. 4, 2013

Related U.S. Application Data
(60) Provisional application No. 61/420,926, filed on Dec. 8, 2010.

(51) Int. Cl. A23L 1/18

(52) U.S. Cl. CPC A23L 1/18
USPC 426/2; 426/625; 426/72; 426/73; 426/61; 426/74; 426/62

(57) ABSTRACT

A gluten free, ready-to-eat food product is provided comprising millet and a flavoring. In some embodiments, the gluten-free food product may also be dairy-free and/or allergen free. In further embodiments, the food products may further comprise one or more vitamins or cofactors therefore, minerals, non-allergenic proteins or amino acids, probiotics, botanicals or combinations of these and be utilized in methods of providing adequate nutrition to individuals diagnosed with an allergy or intolerance. Methods of making the food products, and packaged food products are also provided.

### CROSS REFERENCE TO RELATED APPLICATIONS

This application claims benefit to U.S. Provisional Patent Application No. 61/420,926, filed Dec. 8, 2010, the contents of which are incorporated by reference herein in their entirety.

### BACKGROUND

The present disclosure relates to gluten-free, ready-to-eat food compositions, as well as kits comprising and methods of making the same.

Currently there is an increasing interest in eating more healthful, organic and ecologically sound foods. Interest in locally produced food, community shared agriculture, and cooperative grocery stores offering a wider variety of locally grown and/or organically grown produce and free-range hormone free meat products has grown accordingly. In response to this demand, the supply of these resources has also grown leading to increased choices and convenience for these consumers.

There are a significant number of individuals who are sensitive, for a variety of reasons, to a number of foods. In addition, many consumers choose to avoid certain foods or they may suffer from an intolerance to, certain foods, whether because of the way in which they are processed, e.g., as by the use of herbicides and pesticides, the use of growth inducing hormones, the inclusion of chemical additives and preservatives, and/or processing on equipment or in facilities also used to produce foods containing allergens. Some of these intolerances can rise to the level of health problems, eliciting either an immune response or gastrointestinal symptoms. Wheat gluten is one such food product to which individuals exhibit food sensitivity or food intolerance. Despite the increased interest in healthful, organic and ecologically sound foods and the desire to avoid certain foods due to intolerances or food preferences, there remain few food product choices, particularly convenience items, for the individual with food sensitivities.

Food sensitivities can take on a variety of forms. Food sensitivities often manifest as food allergies. Allergies are caused by the exposure of the individual to allergens that the body sees as foreign and therefore, the body's immune system responds inappropriately. In the instance of food allergies, the allergen may be a protein or glycoprotein that is a natural component of the food, or alternatively, the allergen may be introduced into the food by contamination or processing. Cow's milk, eggs, shellfish, soy, fish, peanuts, tree-nuts and wheat, typically gluten, account for 90% of food allergies and commonly illicit severe allergic reactions in a percentage of the population. Allergy symptoms can include tingling in the mouth, swelling of the tongue and/or throat, breathing hindrance, hives/rash, vomiting, abdominal cramps, diarrhea, lowering of blood pressure, and in extreme cases, loss of consciousness and death.

As noted above, an allergic reaction to gluten (a component of grass-related grains, including wheat, barley and rye) is common and can, depending on the immune system of the individual, be mild or severe. In its severe form, the allergy to gluten manifests as Celiac disease, a cell-mediated disease in which the ingestion of gluten results in an immune response that results in damage to the small intestine. Although many disagree as to whether Celiac disease is properly classified as a food intolerance or food allergy, what is clear is that for those who suffer from this disease are at risk of damage to the small intestine further resulting in malabsorption of nutrients.

Another common allergy to food manifests as lactose intolerance. Lactose intolerance is the inability, or insufficient ability, to digest lactose, a sugar found in milk and milk products. Lactose intolerance is caused by a deficiency of the enzyme lactase, which is produced by the cells lining the small intestine. Lactase breaks down lactose into two simpler forms of sugar, glucose and galactose, which are then absorbed into the bloodstream. Lactose intolerance is not equivalent to cow milk allergy, in which a potentially life-threatening reaction by the body's immune system to one or more milk proteins occurs when just a small amount of milk or milk product is consumed. Milk allergy most commonly appears in the first year of life, while lactose intolerance occurs more often in adulthood.

Currently, about 1 in 25 individuals in the United States suffer from food allergies and 1 in 100 suffers from Celiac disease. As much as 25% of the US population reports some degree of lactose intolerance. No medical cures exist for either Celiac disease, lactose intolerance or other food allergies/intolerances. While lactose intolerance may be somewhat ameliorated if lactase enzymes are consumed prior to the ingestion of dairy products, many lactose intolerant individuals may still experience symptoms, albeit more moderate ones. In many cases, strict avoidance of the allergen, in the case of Celiac disease, gluten, or in the case of lactose intolerance, dairy products, may be required. Convenient food choices are limited for persons allergic to dairy or glutens, therefore, removing the offending ingredients from the diet becomes quite difficult.

Thus, there remains a need for gluten-free, dairy-free food products. The consumer applicability of the gluten-free, dairy-free food product may be further leveraged if the products are also produced free of other allergens, and may even further be produced in accordance with ecologically friendly and/or organic farming practices. The preferred food product is nutritious, of reduced allergen content, satisfying and appealing to consumers.

### BRIEF DESCRIPTION

There is provided herein a gluten-free, dairy-free, ready-to-eat food product comprising millet and a flavoring. The food product may be free-flowing, e.g., may be in the form of cereal, granola, or snack mix, or may be formed into a unitary food product, such as a bar, chip, ball, cracker, cookie or snack bite. In certain embodiments, the food product may further be substantially allergen free and/or certified organic. If desired, the nutritional value of the food product may be enhanced via the inclusion of one or more vitamins, minerals, non-allergenic proteins or amino acids, probiotics, botanicals or combinations of these.

Also provided is a gluten-free, dairy-free, free-flowing, ready-to-eat food product comprising millet, a gluten-free flavoring, oil with or without a plurality of nuts. Examples of nuts used for the purposes of this invention include, but are not limited to, almonds, pumpkin seeds, sunflower seeds, sesame seeds and pecans, in the cases were allergens are not a consideration. Further, the product can contain other grains, such as puffed rice, oats, and the like. The food product may either be sweet or savory, and may also comprise a sweetener. In certain embodiments, the food product may also comprise one or more fruits and or vegetables to further enhance its nutritional value and/or flavor.

Further, a packaged gluten-free, dairy-free food product is provided and comprises millet, a flavoring and packaging. The packaging may be made further attractive to consumers if at least a portion thereof is biodegradable and/or recyclable. Also, the food product may comprise a consumer attractant such as a coupon, a children's toy, literature, e.g., comprising information about food allergies, celiac disease, lactose intolerance, general nutrition, ecologically/environmentally friendly food choices, etc., identifying indicia, or combinations of these. In certain embodiments, the food product may comprise one or more vitamins, minerals, non-allergenic proteins or amino acids, probiotics, botanicals, or combinations of these. In such embodiments, the consumer attractant may desirably comprise identifying indicia on the packaging indicating that the food product is particularly well-suited for the nutritional requirements of a specific age group or gender.

Also provided herein is a method of providing adequate nutrition to an individual suffering from an allergy or intolerance providing the individual with a ready-to-eat food product comprising millet and one or more vitamins or cofactors, minerals, non-allergenic proteins or amino acids, probiotics, botanicals or combinations of these that may otherwise be lacking in the individuals diet due to their allergy or intolerance, or a disease or condition incidental to their allergy or intolerance. In some embodiments, the food product can be gluten-free and used to provide adequate nutrition to an individual suffering from gluten intolerance or celiac disease. Such individuals may also suffer from diabetes, and so, the food product may further comprise a low glycemic index carbohydrate source. Alternatively, the food product may be used to provide adequate nutrition to an individual suffering from lactose intolerance, in which case the food product may be dairy-free and further comprise calcium and vitamin D. Finally, there is provided herein a method for preparing a gluten-free, dairy-free ready-to-eat food product, comprising mixing millet, preferably puffed milled, alone or in combination with another grain such as puffed rice or oats, and a flavoring and heating the mixture. The mixture may conveniently be heated in a conventional or convection oven at temperatures of from about 200° F. to about 450° F., for time periods ranging from about 5 minutes to about 60 minutes. In other embodiments, the food product may be heated in an oven set at a temperature of about 350° F. to about 400° F. for at least about 20 minutes, the oven turned off, and the mixture left in the oven for at least about 10 minutes and up to about 18 hours.

### DETAILED DESCRIPTION

Unless defined otherwise, technical and scientific terms used herein have the same meaning as is commonly understood by one of skill in the art to which this invention belongs. The terms “first”, “second”, and the like, as used herein do not denote any order, quantity, or importance, but rather are used to distinguish one element from another. Also, the terms “a” and “an” do not denote a limitation of quantity, but rather the presence of at least one of the referenced item, and the terms “front”, “back”, “bottom”, and/or “top”, unless otherwise noted, are merely used for convenience of description, and are not limited to any one position or spatial orientation. If ranges are disclosed, the endpoints of all ranges directed to the same component or property are inclusive and independently combinable (e.g., ranges of “up to about 25 wt. %, or, more specifically, about 5 wt. % to about 20 wt. %,” is inclusive of the endpoints and all intermediate values of the ranges of “about 5 wt. % to about 25 wt. %,” etc.). The modifier “about” used in connection with a quantity is inclusive of the stated value and has the meaning dictated by the context (e.g., includes the degree of error associated with measurement of the particular quantity). All percentages are by weight and all solvent mixture proportions are by volume unless otherwise indicated.

There is provided herein a gluten-free, ready-to-eat food product comprising millet and a flavoring. Preferably the food product is also dairy-free. As used herein, the phrase “ready-to-eat” means that additional preparation, for example, cooking or the addition of other ingredients is not required for the food product to be readily consumed. The term gluten-free means less than or equal to 20 ppm of gluten, preferably less than or equal to 200 ppm gluten. Since the food-product is gluten free, it may be enjoyed by individuals with an intolerance to gluten, and/or Celiac disease, or even by consumers who, for whatever reason, wish to limit their intake of gluten. Preferably the food product is dairy-free, (which as used herein means that the food product comprises less than or equal to 0.5% lactose); therefore, it may be enjoyed by those with an intolerance to dairy, including lactose intolerance. The food product thus advantageously provides an additional nutritional choice in a food category with otherwise limited choices.

The food product described herein advantageously comprises millet. The millets are a group of small-seeded species of cereal crops or grains. The millets include species mostly in the subfamily Panicoideae, of the grass family Poadeae. Any millet may be used in the present food product, including but not limited to pearl millet (Pennisetum glaucum), foxtail millet (Setaria italica), proso millet, also known as common millet, broom corn millet, hog millet, or white millet (Panicum miliaceum), finger millet (Eleusine coracana), barnyard millet (Echinochloa spp.), Kodo millet (Paspalum scrobiculatum), little millet (Panicum sumatrense), japanese millet (Echinochloa esculenta), guinea millet (Brachiaria deflexa=Urochloa deflexa), and browntop millet (Urochloa ramosa=Brachiaria ramosa=Panicum ramosum). A combination of any number of millets may also be utilized.

The protein content in millet is very close to that of wheat; both provide about 11% protein by weight. Advantageously, however, millets contain no gluten and while not suitable as a substitute for wheat in raised breads, it is an appropriate food for those with Celiac disease, or other forms of allergies or for those individuals with a digestive system that is intolerance to wheat. Millets are, advantageously, rich in B vitamins, especially niacin, B6 and folic acid, as well as calcium, iron, potassium, magnesium and zinc.

The millet utilized in the food product may desirably be puffed, popped, or otherwise expanded. The millet may either be purchased in a puffed state from any number of commercial sources, (such as Arrowhead Mills, Boulder CO), or may be puffed prior to incorporation into the food product by any known method. Typically, grains are puffed according to one of the following methods: (i) heating the kernels of grain until they become extensible (i.e., until the starch becomes amorphous or flowable) at which point further heating permits evaporation of moisture (and outgassing of minor amounts of other gases entrained in the grain) which causes expansion (bubble formation) in the amorphous starch; (ii) heating the grain kernels to a flowable state at atmospheric pressure, then suddenly reducing the pressure (partial vacuum) again permitting enhanced vaporization and out-gassing, and again causing expansion (bubble formation) in the amorphous starch; or (iii) heating the grain kernels to a flowable state in a chamber where pressure is permitted (or caused) to build, then suddenly reducing the pressure to atmospheric, permitting enhanced vaporization and out-gassing and again causing expansion (bubble formation) in the amorphous starch. Any of these may be utilized to puff the millet, in embodiments where the same is desired. The food product also desirably comprises a flavoring. The following exemplary patents and patent applications disclose various methods for puffing grains such as milled: US Publication No. 20070160727 entitled “Process for Preparation of Expanded Millet, U.S. Pat. No. 3,650,763 entitled “High Pressure Process for making Puffed Food Product and Product”, U.S. Pat. No. 4,281,593 entitled “Device for Preparing Food Products from Cooked and Expanded Cereals and Products Obtained”, U.S. Pat. No. 4,667,588 entitled “Methods of Producing Crackers and Apparatus for Carrying out the Same”, U.S. Pat. No. 4,734,289 entitled “Food Materials for Puffing”, and U.S. Pat. No. 4,888,180 entitled “A method of Preparing Grain Cakes.”

As used herein, the term “flavoring” includes salts, seasonings or any other ingredient that may make the food product more appealing to the taste. Examples of flavorings include, but are not limited to, mint, spearmint, peppermint, cinnamon, nutmeg, cloves, ginger, wintergreen, vanilla, nut flavorings, fruit extracts and essences, peppers, including black and chili peppers, salt, garlic, any other flavoring known to those of ordinary skill in the art, as well as combinations of any of these. In certain embodiments, the flavoring is desirably devoid of gluten, lactose, cow's milk, eggs, shellfish, soy, fish, peanuts, tree-nuts and wheat. Because of their wide acceptance and popularity, as well as their ability to mask other undesirable flavors, preferred flavorings for inclusion in the food product may include vanilla, maple, chocolate, raw chocolate, carob, cinnamon and the like.

The flavorings can be added in any proportion or combination to achieve the desired taste. For example, salt and vanilla can comprise any proportion of the total flavoring, but generally, comprise less than about 5 wt %, or less than 2 wt %, or even less than 0.1 wt % of the total weight of the food product. Generally speaking, those of ordinary skill in the manufacture of food products are familiar with the acceptable ranges for such flavorings, and are capable of determining adequate levels of whatever flavoring is desired. Maximum amounts of flavorings are generally limited only by practical considerations, and may be included in amounts that do not substantially detrimentally impact the taste, texture, processability and/or cost of the food product, or in amounts of up to about 50 wt % of the entire weight of the food product.

As noted above, in order to be appealing and/or nutritionally useful to an even larger segment of consumers, the gluten-free, dairy-free food product may further be substantially allergen free. As used herein, the phrase “substantially allergen free” means that the food product comprises levels of cow's milk, eggs, shellfish, soy, fish, peanuts, tree-nuts and wheat that provide No Observed Adverse Effect Level (NOAEL) or Lowest Observed Adverse Effect Level (LOAEL), or an equivalent, as defined by the US Food and Drug Administration. Preferably, the substantially allergen free food products contain levels of cow's milk, eggs, shellfish, soy, fish, peanuts, tree-nuts and wheat that are at least within the LOAEL limit. The LOAEL levels of these allergens are currently as follows: cow's milk, from about 0.36 mg to about 3.6 mg protein; eggs, from about 0.13 mg to about 1.0 mg protein; fish and shellfish, from about 1 mg to about 100 mg protein; soy, from about 88 mg to about 522 mg protein; peanuts, from about 0.25 mg to about 10 mg protein; tree nuts, from about 0.02 mg to about 7.5 mg protein but these levels do not necessarily ensure that the product will not contain other allergens that affect a minor portion of the population.

The appeal/value of the food product may be further enhanced if provided in a certifiably organic form. As used herein, the phrase “certified organic” or “certifiably organic” means that components utilized in the food product have been grown according to strict uniform standards that are verified by independent state or private organizations. Certification includes inspections of farm fields and processing facilities, detailed record keeping, and periodic testing of soil and water to ensure that growers and handlers are meeting the standards which have been set. Information about these standards can be found at the website for the Organic Trade Association (OTA, Brattleboro, Vt.).

The food product may be provided in either a free-flowing state, or as a unitary food product. In the case of the former, the food product may be provided, e.g., as a cereal, a granola, a snack mix, a topping or the like. In the case of the latter, the food product may be formed into any desired shape, including bars, balls, chips, crackers, cookies, snack bites, etc. If provided as a unitary food product, the food product may be provided in a size that is considered a single serving, such as a 2 inch by 4 inch bar, or a 3 inch diameter cookie, a multiple serving size or may be provided in a “mini” size, wherein a plurality of the food products are considered a single serving.

In order to provide even further nutritional value to the consumers thereof, the food products may additionally comprise one or more vitamins or cofactors therefore, minerals, non-allergenic proteins or amino acids, probiotics, botanicals or combinations of these. Further, these may be provided as a component of one of the other optional ingredients of the food product, or may be provided separately. Those of ordinary skill in the art are very familiar with these ingredients, their sources, and their appropriate amounts. As such, any known vitamin or cofactor therefore, mineral, non-allergenic protein or amino acid, probiotic, botanical or combination thereof may be used in the present food product, in any amount that does not induce toxicity in the consumer. For many of these, the United States Department of Agriculture (USDA) publishes Recommended Dietary/Daily Allowances, or Dietary Reference Intakes (see the website for the Food and Nutritional Information Center, National Agricultural Library, USDA), and any amount up to these recommended daily allowance of these, e.g., from about 0.01% to about 100% of the recommended daily allowance, may be included in the food products.

Examples of vitamins or cofactors therefore, and exemplary amounts thereof, that may be included in the food product in certain embodiments, include, but are not limited to, one or more B-vitamins, including B₁ (thiamine, or thiamine mononitrate, from about 1 mg to about 20 mg), B₂ (riboflavin, from about 1 mg to about 20 mg), B₃ (niacinamide, from about 0.01 mg to about 25 mg), B₅ (from about 1 mg to about 50 mg), B₆ (from about 1 mg to about 10 mg), biotin (from about 1 mg to about 300 mg), folic acid (from about 1 mg to about 400 mg) and B₁₂ (from about 1 to about 1000 mg); vitamin C (ascorbic acid, from about 20 mg to about 120 mg); vitamin A (from about 100 micrograms to about 2000 micrograms); vitamin D (from about 5 micrograms to about 50 micrograms); vitamin K (from about 10 micrograms to about 1000 micrograms); para-aminobenzoic acid (from about 50 micrograms to about 500 micrograms); inositol (from about 50 milligrams to about 100 grams); alpha-lipoic acid (from about 0.01 mg to about 300 mg); coenzyme Q10 (from about 0.01 mg to about 80 mg) or combinations of these. In some embodiments, the one or more vitamins may desirably comprise one or more B-vitamins, vitamin C, vitamin D or combinations thereof. Because lactose intolerant individuals may typically also suffer from vitamin D deficiencies, the inclusion of vitamin D may be particularly preferred in some embodiments of the food product.

Examples of minerals that may be included in the food products provided in this invention include, but are not limited to, magnesium, iron, zinc, copper, manganese, sodium, potassium, calcium, selenium, chromium, molybdenum, chlorine, fluorine, phosphorus, sulfur, iodine, or combinations of these. In some embodiments, the one or more minerals may desirably comprise magnesium, calcium, iron, zinc, or combinations of these. Because lactose intolerant individuals may typically also exhibit calcium deficiency, the inclusion of calcium may be particularly preferred in some embodiments of the food product.

Non-allergenic proteins or amino acids may be included in the food products to supplement the protein intake of a consumer of the food products and examples of these include, but are not limited to, vegetable proteins, such as those derived from spelt, quinoa, amaranth, buckwheat, rice (such as black rice, wild rice, brown rice, etc), fava flour, garbanzo flour and the like. Certain proteins and amino acids, such as leucine, creatine, arginine and L-proprionyl carnitine, may be produced by microbial methods and any of these may also be included in the food products. Taurine may also be nutritionally useful for some consumers, and may be included in the food products, in amounts from about 0.5 g to about 3 g.

Generally speaking, the amounts of non-allergenic proteins or amino acids is only limited by practical considerations, such as processability, taste and texture, and these ingredients may typically be included in the food product in amounts of up to about 70 wt % of the food product, or so that the total protein content of the food product is at least about 1 g of protein, or about 2 g of protein, or about 3 g of protein, etc., up to and including about 10 g of protein.

The food products may also advantageously include one or more probiotics. Probiotics are dietary supplements of live microorganisms thought to be healthy for the host organism. According to the currently adopted definition by the World Health Organization, probiotics are “live microorganisms which when administered in adequate amounts confer a health benefit on the host.” Lactic acid bacteria and bifidobacteria are the most common types of microbes used as probiotics, but certain yeasts and bacilli are also available and any of these may be used in the present food products.

Examples of botanicals that may be included in the present food products, if desired, include bilberry, cascara, cat's claw, cayenne, cranberry, devil's claw, dong quai, Echinacea, evening primrose oil, feverfew, garlic, ginger, ginkgo, Asian ginseng, Siberian ginseng, goldenseal, gotu kola, grape seed, green tea, hawthorn, kava, licorice, milk thistle, noni, saw palmetto, St. John's wort, valerian, melatonin, damiana, yerbe mate, guarana, red yeast rice, or combinations of these. As with the vitamins, minerals, proteins, amino acids and probiotics, those of ordinary skill in the food and nutritional arts are well aware of appropriate amounts of botanicals that may be included in the food products, and these amounts are generally only limited by the desire to not detrimentally impact the taste, texture, processability and/or cost of the food product.

The food product may also desirably include an amount of a liquid to add moisture to the food product and to assist in the homogenous mixing of the ingredients to provide a substantially homogeneous food product. Desirably, the amount of liquid included will be an amount that upon heating, will substantially evaporate or otherwise dry, so that the food product has a crispy texture. It is to be understood that the desired flavoring included in the food product may also act as a liquid, as may the optional sweetener, and that other suitable liquids include, but are not limited to, vegetable or fruit juice, water, rice milk, soy milk, hemp milk, oil, gluten-free vinegar, e.g., balsamic vinegar, or combinations of these. The total amount of any liquid ingredients in the food product will desirably be within the range of at least about 1:5 to about 1:15, and more preferably from about 1:7 to about 1:12 liquid to dry ingredients. Where the avoidance of allergens is desired, liquid used in the food product will desirably be substantially free of gluten, lactose, cow's milk, eggs, shellfish, soy, fish, peanuts, tree-nuts and wheat.

The food product may optionally further include a sweetener, and any desired sweetener can be chosen from among the many known sweeteners appropriate for use in food products. Any such sweetener will desirably be devoid of gluten, lactose, cow's milk, eggs, shellfish, soy, fish, peanuts, tree-nuts and wheat. The optional sweetener can be refined (such as glucose, etc.) or unrefined, natural or artificial, or a blend of these. One exemplary preferred sweetener that also functions as a liquid that aids in the processing of the food product comprises maple syrup, preferably pure maple syrup. In these embodiments of the invention, the maple syrup is desirably present in the food product in a ratio of from about 1:8 to about 1:12 maple syrup to other ingredients of the food product. In other embodiments artificial or natural sweeteners may be used. These sweeteners are suitable for ingestion by individuals who prefer or require sweeteners having few or no calories, sweeteners that do not substantially increase blood sugar levels and/or cause little or no insulin to be released. Examples of such sweeteners include, but are not limited to, sugar alcohols (such as mannitol, sorbitol, xylitol, lactitol, isomalt, maltitol) and high intensity artificial sweeteners (such as aspartame, alitame, cyclamates, saccharin, accsulfamie, sucralose, stevia sweeteners, and the like). Other low or no calorie sweeteners include, but are not limited to, stevia, agave, palm sugar and jaggery. The amount of any desired sweetener can range from about 1 wt % to about 80 wt % based upon the total weight of the food product.

The food products of the present invention may optionally include a plurality of nuts or seeds and/or one or more vegetables and/or fruits, which in some instances, can provide an additional source of protein and/or fiber within the food product. Any desired nut can be included in the present food product, and examples of those suitable include pecans, walnuts, almonds, hazelnuts, pistachio nuts, filberts, cashews, peanuts, coconut, sunflower seeds, pumpkin seeds and the like. In those embodiments of the invention wherein the food product is desirably substantially allergy free, the food product may comprise sunflower seeds or pumpkin seeds to provide a texture similar to nuts if the same is desired, but will necessarily be devoid of peanuts or tree nuts.

If fruits and/or vegetables are desirably included in the food products, any known fruits or vegetables may be utilized, and the choice of which to include may be based solely on consumer preference and/or nutritional value provided by the fruit(s) and/or vegetable(s). The desired fruit(s) and/or vegetable(s) will preferably have an organoleptically desirable texture when dried. Examples of suitable fruits and vegetables that may be included in the food products include, for example, banana, apple, pear, blueberry, pomegranate, strawberry, cherry, cranberry, raisins, soybeans, peas, beans, carrots, beets, corn, or combinations of these. In those embodiments wherein a substantially allergy free food product is desired, soybeans will necessarily be excluded. Where desired, and often preferred, the fruits, grains and vegetables used in the present invention are grown organically, are not genetically modified and are pesticide free.

The food products described herein may also comprise a dressing and/or topping to add flavor, texture, and/or visual appeal to the food product. Such dressings/toppings include, but are not limited to, chocolate, caramel, peanut butter, fruit and other grains, and may be incorporated into the food product via any of several known methods.

The food product may optionally include any other ingredients necessary or desirable to facilitate processing of the food product. For example, the food product may include a gelling agent, such as tapioca, corn starch, gelatin and the like to assist in the formation of the food product into a unitary shape, such as a bar, chip, cracker, cookie etc., in those embodiments wherein the same is desired. Desirably, the gelling agent will be substantially free of gluten, lactose, cow's milk, eggs, shellfish, soy, fish, peanuts, tree-nuts and wheat. The amount of gelling agent required in order to form the food product will necessarily depend on the other components of the food product, as well as the formed shape desirably attained, but generally speaking, the gelling agents listed above will be useful in amounts of from about 0.001 wt % to about 5 wt % of the total weight of the food product.

In those embodiments wherein the food product is desirably shaped into a form, such as a bar, cookie, chip, cracker, etc., the food product may also optionally include a bulking agent. Not only do such agents provide a bulk that may assist in the formation of the desired shape, but they may also assist in providing a desired texture or consistency to the food product. Any known food grade bulking agent can be used for this purpose that is desirably free of gluten, lactose, cow's milk, eggs, shellfish, soy, fish, peanuts, tree-nuts and wheat. Examples of such bulking agents include, but are not limited to, inulin, oligofructose, one or more sugar alcohols, and the like. Of these inulin and oligofructose may be preferred, in particular in those embodiments wherein the food product is contemplated for ingestion by a diabetic. Inulin and oligofructose can substantially mimic sugar's viscosity, texture, humectancy, freezing point depression and water binding activity. They exhibit mild sweetness and can also form a gel that allows the food product to be more easily shaped, if the same is desired. They are also good sources of dietary fiber.

One or more emulsifying agents may also optionally be included in the food product in amounts of from about 0.001 wt % to about 15 wt % of the total weight of the food product. Examples of emulsifying agents include, but are not limited to agar, albumin, alginates, casein, egg yolk, glycerol monostearate, gums, Irish moss, lecithin and the like. In those embodiments wherein the food product is desirably allergen free, any emulsifying agent will desirably be substantially free of gluten, lactose, cow's milk, eggs, shellfish, soy, fish, peanuts, tree-nuts and wheat.

The food product is desirably provided to the consumer in packaging, which may optionally be either biodegradable and/or recyclable. Further, the packaging may include many servings packaged together, or, may consist of secondary packaging comprising individual serving sizes of the food product. The packaging may also optional comprise a consumer attractant, such as a coupon, a children's toy, literature, identifying indicia or combinations of these. For example, the packaging may comprise literature further comprising information about nutrition, ecologically/environmentally friendly food choices, Celiac disease, food allergies, lactose intolerance or a combination of these. Or, in those embodiments wherein the food product further comprises one or more vitamins or cofactors therefore, minerals, non-allergenic proteins or amino acids, probiotics, botanicals or combinations of these, the consumer attractant may comprise indicia indicating that the food product is particularly well-suited for the nutritional requirements of a specific age group, gender, group of individuals suffering from a particular intolerance or food allergy or combinations of these.

As mentioned hereinabove, the food product may be formulated to provide nutrition to those suffering from intolerances or allergies. Many of these individuals may also suffer from other nutritional deficiencies, or even secondary conditions, due at least in part to their primary allergy or intolerance. For example, individuals with an intolerance for gluten may struggle to ingest adequate levels of carbohydrates. These individuals also have a tendency to develop diabetes, and so, in certain embodiments the food product may further comprise inulin and/or a low glycemic index carbohydrate. Additionally, individuals exhibiting gluten intolerance may have difficult absorbing other nutrients from their small intestine, and so, in some embodiments, the food product may further comprise one or more B-vitamins, also difficult for some individuals to absorb, either due to disease, age, or surgery to the small intestine. Also, individuals that are lactose intolerant may have difficulty acquiring adequate amounts of calcium and vitamin D from their diet, and these may be included in food products according to some embodiments. Any of these embodiments may be packaged according to the present invention, in packaging comprising identifying indicia indicating that the food product is particularly well suited for ingestion by gluten-intolerant or lactose intolerant individuals, as the case may be.

Further, because the food products are ready and efficient carriers for vitamins or cofactors therefore, minerals, non-allergenic proteins or amino acids, probiotics, botanicals, or combinations of these and the commercial availability of the latter, the food products are readily and easily tailored to a particular individual's nutritional needs. As such, the present invention can also provide adequate nutrition to an individual suffering from an allergy or intolerance. More particularly, the method comprises providing the individual with a ready-to-eat food product comprising millet and at least one vitamin or cofactor therefore, minerals, non-allergenic proteins or amino acids, probiotics, botanicals or combinations of these that may otherwise be lacking in the individual's diet due to their allergy or intolerance, or a disease or condition incidental to their allergy or intolerance.

As described above, in those embodiments wherein the individual suffers from a gluten intolerance and/or Celiac disease, the food product may additionally optionally comprise one or more B-vitamins in an amount effective to elevate the individuals level in the blood of the same, and for those individuals who also suffer from diabetes, inulin and/or a low glycemic index carbohydrate. Or, in those embodiments, wherein the allergy or intolerance comprises lactose intolerance and the food product may desirably be diary-free and further comprise calcium and/or vitamin D in amounts effective to elevate the level of the same in the blood of the individual.

The present food products are readily and easily manufactured on equipment typically found in food manufacturing facilities, and thus, methods for their preparation are also provided herein. Generally speaking, the method involves combining the dry ingredients, separately combining any liquids desirably included in the food product, and then combining the wet and dry ingredients. In those embodiments of the invention comprising nuts and/or seeds, these may be added after the dry and wet ingredients are combined in order to preserve the texture of the same. Any known device capable of mixing wet and dry ingredients can be used in this portion of the method.

In certain embodiments, the mixture may then be formed into a desired shape, or may be delivered directly to a pan suitable for heating, if a free-flowing food product is desired. If the food product is desirably shaped, it can be cold pressed into the desired shape, e.g., a cookie, cracker, chip, bar, etc. Or, the food product may be extruded via a conventional confectionary bar type extruder, such as a Werner-Lahara bar extruder. In this case, the desired shape may be obtained by utilized the appropriately shaped extruder die. The extrudate may then be cut into individual serving size pieces, by means of a guillotine-type cutter or wire cutter in a conventional manner.

If a dressing or topping is desirably included in the food product, it may then be applied to the free-flowing or shaped food product. Any dressing or topping may also be applied after baking. The dressing and/or topping may be applied by coating, enrobing, spraying or dipping the food product with the dressing/topping material.

The food product is then desirably heated until the desired texture is obtained. Typically, the food product is baked in an oven, either a conventional or convection oven, set at a temperature that browns and/or crisps the food product in a commercially reasonable amount of time, typically less than about 30 minutes, or even less than about 20 minutes. Temperatures of from about 200° F. to about 450° F. are appropriate, and temperatures of from about 350° F. to about 400° F. are preferred in some embodiments. Alternatively, the food product may be baked in an oven set at the desired temperature for the desired amount of time, the oven turned off, and the food product allowed to cool in the oven over night.

Once cooled, the food product may be packaged in any desired package, either in sizes comprising multiple servings, or in secondary packages comprising individual servings. The packaging may further be flushed with inert gas, such as nitrogen, if desired, in order to reduce the oxygen content in the package, thereby increasing the shelf life of the food product.

The following example illustrates certain aspects and embodiments of the present invention. These examples should not be construed as limiting.

### EXAMPLE 1

### Millet Snack Food

This is one example of a food product in accordance with the present invention, formulated to be gluten-free, dairy-free and free flowing. The food product comprises: whole grain puffed millet, maple syrup, vegetable oil, pecans, and gluten free vanilla extract or essence.

As one example of how the food product can be combined, 11 cups of whole grain puffed millet is placed in a large bowl. In a separate bowl ½ cup maple syrup, ⅓ cup vegetable oil and 1 teaspoon vanilla are combined, and then added to the millet. The combination is mixed and 1 cup of pecans is added. The mixture is transferred to a baking tray lined with parchment paper, and spread into a single layer. The mixture is heated in an oven set at 350° F., with stirring, for from about 20 minutes to about 30 minutes or until the food product has reached the desired texture. The food product is removed from the oven and allowed to cool. The food product is then packaged as desired.

### Example 2

### Healthy Millet Cookies

In another example of this invention, the product is prepared as a cookie comprising almonds, whole grain puffed millet, a dried fruit, such as cherries, raisins, dates, or the like.

2½ cups almonds were ground to a course flour in a blender or food processor. The dried fruit, here 1 cup of preferably chemically free dried cherries were roughly chopped. ½ cup of coconut oil is warmed over low heat until the coconut oil is liquefied. ½ cup Agave nectar and 1 Tablespoon vanilla extract was mixed into the coconut oil. The almonds, 1 cup of puffed millet, 3 Tablespoons raw cacao powder, ½ Tsp salt, preferably Redman's brand Real Salt, ½ tsp baking soda and optionally ½ up to 1 cup of chocolate chips is mixed together and add in the coconut oil mixture. Baking trays were lined with parchment and tablespoons of dough were placed on to the parchment paper. The cookies were baked for 10-15 minutes at 350 F. For a rounder cookie, the dough was rolled into balls and pressed with a fork to flatten. For a sweeter cookie raisins or chopped dates were used in place of the cherries. For additional fiber, ½ cup of ground flax seeds was added to the dry ingredients prior to combination with the coconut oil mixture.

### EXAMPLE 3

### Millet Power Bars

In yet another example, the compositions of this invention can be formed into bars. One such example of a bar is provided here.

½ cup almonds, ½ cup walnuts, ½ cup sunflower seeds, ½ cup pumpkin seeds, ½ cut flax meal, 1 cup dried cherries, preferably chemical-free, ¼ tsp salt, preferably Redman's Real Salt were pulsed briefly in a food processor. Separately ⅓ cup coconut oil was warmed over low heat until the consistency was liquid and combined with ½ cup Agave nectar and 1 Tablespoon Vanilla Extract. Add the liquid mixture to the dry mixture and pulse until blended. Line an 8×8 inch baking dish with parchment paper and press mixture into the dish. Refrigerate until firm (at least about 60 minutes), remove and cut into bars. For a sweeter bar substitute raisins or dates for the cherries and for a crispier bar dehydrate for 12-24 hours in a food dehydrator (e.g., Excalibur Food Dehydrator, Sacramento, Calif.)

All patents, patent applications, provisional applications, and publications referred to or cited herein are incorporated by reference in their entirety to the extent they are not inconsistent with the explicit teachings of this specification. Further, while only certain features of the invention have been illustrated and described herein, many modifications and changes will occur to those skilled in the art. It is, therefore, to be understood that the appended claims are intended to cover all such modifications and changes as fall within the true spirit of the invention.

1. A gluten-free, dairy-free, ready-to-eat food product comprising puffed millet and a flavoring.

2. The food product of claim 1, wherein the food product is free-flowing.

3. The food product of claim 2, wherein the food product comprises cereal, granola, or snack mix.

4. The food product of claim 1, formed into a unitary food product.

5. The food product of claim 4, wherein the food product comprises a bar, chip, cookie or cracker.

6. The food product of claim 1, wherein the food product is substantially allergen free.

7. (canceled)

8. The food product of claim 1, further comprising one or more vitamins, minerals, non-allergenic proteins or amino acids, probiotics, botanicals, or combinations of these.

9. The food product of claim 8, further comprising one or more vitamins such as one or more B-vitamins, vitamin C, vitamin A, vitamin D, vitamin K, para-aminobenzoic acid, inositol, alpha-lipoic acid, choline, coenzyme Q10 or combinations of these.

10. The food product of claim 9, wherein the one or more vitamins comprise one or more B-vitamins, vitamin C, vitamin D or a combination of these.

11. The food product of claim 8, further comprising one or more minerals such as magnesium, iron, zinc, copper, manganese, sodium, potassium, calcium, selenium, chromium, molybdenum, chlorine, fluorine, phosphorus, sulfur, iodine, or combinations of these.

12. The food product of claim 11, wherein the one or more minerals comprise magnesium, calcium, or a combination of these.

13. The food product of claim 8, further comprising one or more nonallergenic proteins comprising vegetable-based or microbially produced proteins.

14. The food product of claim 13, wherein the vegetable-based protein comprises spelt, quinoa, amaranth, buckwheat, rice, fava flour, garbanzo flour or combinations of these.

15. The food product of claim 13, wherein the protein is microbially produced and comprises leucine, creatine, arginine, 1-propionyl carnitine, or combinations of these.

16. The food product of claim 8, further comprising one or more probiotics such as lactic acid bacteria, bifidobacteria, yeasts, bacilli or combinations of these.

17. The food product of claim 8, further comprising one or more botanicals such as bilberry, cascara, cat's claw, cayenne, cranberry, devil's claw, dong quai, Echinacea, evening primrose oil, feverfew, garlic, ginger, ginkgo, Asian ginseng, Siberian ginseng, goldenseal, gotu kola, grape seed, green tea, hawthorn, kava, licorice, milk thistle, noni, saw palmetto, St. John's wort, valerian, melatonin, damiana, yerbe mate, guarana, red yeast rice, or combinations of these.

18. A gluten-free, dairy-free, free-flowing, ready-to-eat food product comprising puffed millet, a gluten-free flavoring, oil and a plurality of nuts and/or seeds.

19-30. (canceled)

31. A method of providing adequate nutrition to an individual diagnosed with an allergy or intolerance comprising providing the individual with a ready-to-eat food product comprising millet and one or more vitamins or cofactors therefore, minerals, non-allergenic proteins or amino acids, probiotics, botanicals or combinations of these that may otherwise be lacking in the individuals diet due to their allergy or intolerance, or a disease or condition incidental to their allergy or intolerance.

32. The method of claim 31, wherein the allergy or intolerance comprises gluten intolerance or celiac disease, the ready-to-eat food product is gluten-free, the incidental disease or condition comprises diabetes and the food product further comprises insulin and/or a low glycemic index carbohydrate.

33. The method of claim 31, wherein the allergy or intolerance comprises lactose intolerance and the food product is diary-free and further comprises calcium and vitamin D.

34-42. (canceled)
